(19) United States
(12) Patent Application Publication
(10) Pub. No.: US 2017/0315675 A1
(43) Pub. Date: Nov. 2, 2017

(54) SYSTEMS AND METHODS FOR DETERMINING SEEK POSITIONS

(71) Applicant: Google Inc., Mountain View, CA (US)

(72) Inventors: Andrew Lewis, London (GB); Oliver Woodman, London (GB)

(21) Appl. No.: 15/139,753

(22) Filed: Apr. 27, 2016

(51) Int. Cl. G06F 3/0481

(52) U.S. Cl. CPC G06F 3/0481

(57) ABSTRACT

Aspects of the technology include receiving (702) data indicative of a change from a first status to a second status, generating (704) a timestamp indicative of a time at which the change in status occurred, and storing (706) the timestamp in memory. Further aspects include receiving (708) data indicative of a reversion to the first status and, responsive thereto, retrieving (710) data indicative of the timestamp from memory. Additionally, aspects include providing (712) data indicative of the timestamp to an application configured for making content available to a user. The data indicative of the timestamp may initiate playback of the content to a time at which the change in status occurred.

### BACKGROUND

Interactive audio and video players generally provide controls that allow a user to navigate the content they are experiencing. For example, most players provide fast forward and rewind buttons or, in the case of a tablet or mobile device, a user interface that allows a user to select a desired position in the content at which to commence or continue playback (e.g., by entering a dragging input). Such controls can frustrate users, however, because (i) they are often too imprecise to allow the user to precisely navigate to a desired location, (ii) buffering can prevent the content from restarting at a desired position or prevent the content from starting at the desired position quickly, or (iii) in the case of a user who's attention is diverted away from the content, the user does not know the desired location to begin with because they are unsure of the instance at which their attention was diverted.

### BRIEF DESCRIPTION OF THE FIGURES

Reference will now be made to the accompanying FIGS., which are not necessarily drawn to scale, and wherein:

FIG. 1 depicts computing system architecture 100, according to an example implementation of the disclosed technology.

FIG. 2 illustrates an example communication flow 200, according to an example implementation.

FIG. 3 illustrates an example communication flow 300, according to an example implementation.

FIG. 4 illustrates an example communication flow 400, according to an example implementation.

FIG. 5 illustrates an example communication flow 500, according to an example implementation.

FIG. 6 illustrates an example communication flow 600, according to an example implementation.

FIG. 7 is a flow diagram of a method 700, according to an example implementation.

### DETAILED DESCRIPTION

Some implementations of the disclosed technology will be described more fully with reference to the accompanying drawings. This disclosed technology may, however, be embodied in many different forms and should not be construed as limited to the implementations set forth herein.

Example implementations of the disclosed technology can provide systems and methods for determining seek positions in content being output by a content application such that it can be experienced by a user. For example, some implementations may utilize a mobile or wearable device's various sensors and inputs including, for example, a gyroscope, accelerometer, microphone, or light sensor to, for example, determine if the user's physical activity, environment, or location has changed while the user is experiencing the content. Thus in an example implementation, if a user watching a television show changes a seating position or goes into a different room, a sensor in the user's wearable device can detect the change in the user's location and communicate the change in location to a server, which can then generate and store a timestamp that corresponds to the time of the change in location. If, for example, the user returns to the room and sits back down, the user's wearable device can detect that the user has returned to the original location (i.e., sitting in the initial room). In this example, the wearable device then can communicate to the server that the user has returned to the original location, and the server then can provide the timestamp to the content application currently outputting the television show for viewing by the user. Based on the timestamp, the application can rewind (or provide the option to the user to rewind) the television show to the portion of the content that was being output at the moment when the user changed seating positions or exited the room.

In a similar example, if a user is watching a television show and begins a conversation, a microphone in the user's mobile device can detect the change in the user's physical activity (i.e., that the user has gone from not talking to talking). Accordingly, the user's mobile device can communicate the change in physical activity to a server that, as before, can generate and store a timestamp that corresponds to the change in physical activity. When the conversation ends, the microphone of the mobile device can detect the end of the conversation and the return to the original physical activity of not talking. Accordingly, the mobile device can communicate to the server that the user's physical activity has reverted, and the server can provide the timestamp to the content application outputting the television show for viewing by the user. Accordingly, based on the timestamp, the content application can rewind or allow the user the rewind the television show to the point at which the conversation started.

In some implementations of the disclosed technology, the user's mobile or wearable device can create a timestamp upon receiving an indication of a change in location or physical status from a sensor of the device. Subsequently, upon receiving an indication of a reversion to the original location or physical status from a device sensor, the mobile device can communicate the timestamp to a remote computing device, which can then communicate the timestamp to an application making media content available to the user. Similarly, in some implementations, the mobile device can communicate the timestamp directly to the application making the content available.

Example implementations of the disclosed technology will now be described with reference to the accompanying figures.

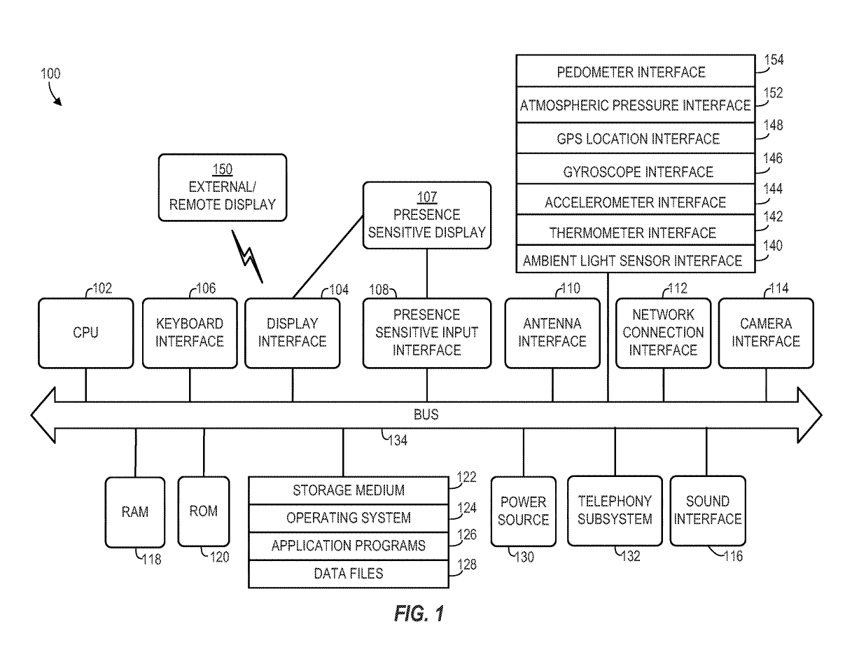

As desired, implementations of the disclosed technology include a computing device with more or fewer of the components illustrated in FIG. 1. A computing device that comprises the components illustrated in FIG. 1 can be referred to as, for example, a mobile device, a wearable device, or a server, in addition to a computing device. It will be understood that the computing device architecture 100 is provided for example purposes only and does not limit the scope of the various implementations of the present disclosed systems, methods, and computer-readable mediums.

The computing device architecture 100 of FIG. 1 includes a central processing unit (CPU) 102, where computer instructions are processed; a display interface 104 that supports a graphical user interface and provides functions for rendering video, graphics, images, and texts on the display. In certain example implementations of the disclosed technology, the display interface 104 connects directly to a local display, such as a touch-screen display associated with a mobile computing device. In another example implementation, the display interface 104 can be configured for providing data, images, and other information for an external/remote display 150 that is not necessarily physically connected to the mobile computing device. For example, a desktop monitor may be utilized for mirroring graphics and other information that is presented on a mobile computing device. In certain example implementations, the display interface 104 wirelessly communicates, for example, via a Wi-Fi channel or other available network connection interface 112 to the external/remote display.

In an example implementation, the network connection interface 112 is configured as a wired or wireless communication interface and provides functions for rendering video, graphics, images, text, other information, or any combination thereof on the display. In one example, a communication interface includes a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device architecture 100 may include a keyboard interface 106 that provides a communication interface to a physical or virtual keyboard. In one example implementation, the computing device architecture 100 includes a presence-sensitive display interface 108 for connecting to a presence-sensitive display 107. According to certain example implementations of the disclosed technology, the presence-sensitive input interface 108 provides a communication interface to various devices such as a pointing device, a capacitive touch screen, a resistive touch screen, a touchpad, a depth camera, etc. which may or may not be integrated with a display.

The computing device architecture 100 may be configured to use one or more input components via one or more input/output interfaces (e.g., the keyboard interface 106, the display interface 104, the presence sensitive input interface 108, network connection interface 112, camera interface 114, sound interface 116, pedometer interface 154, atmospheric pressure interface 152, GPS location interface 148, gyroscope interface 146, accelerometer interface 144, thermometer interface 142, ambient light sensor interface 140, etc.) to allow the computing device architecture 100 to present information to a user and capture information from a device's environment including instructions from the device's user. The input components may include a mouse, a trackball, a directional pad, a track pad, a touch-verified track pad, a presence-sensitive track pad, a presence-sensitive display, a scroll wheel, a digital camera, a digital video camera, a web camera, a sensor, a smartcard, and the like. Additionally, an input component may be integrated with the computing device architecture 100 or may be a separate device. As additional examples, input components may include an accelerometer, a gyroscope, a pedometer, a magnetometer, a microphone, a thermometer, and an optical sensor.

Example implementations of the computing device architecture 100 include an antenna interface 110 that provides a communication interface to an antenna; a network connection interface 112 may support a wireless communication interface to a network. As mentioned above, the display interface 104 may be in communication with the network connection interface 112, for example, to provide information for display on a remote display that is not directly connected or attached to the system. In certain implementations, the computing device architecture 100 includes a camera interface 114 that acts as a communication interface and provides functions for capturing digital images from a camera. In certain implementations, the computing device architecture 100 includes a sound interface 116 that serves as a communication interface for converting sound into electrical signals using a microphone and for converting electrical signals into sound using a speaker. According to example implementations, the computing device architecture 100 includes a random access memory (RAM) 118 where computer instructions and data may be stored in a volatile memory device for processing by the CPU 102.

According to example implementations, the computing device architecture 100 includes a read-only memory (ROM) 120 where invariant low-level system code or data for basic system functions such as basic input and output (I/O), startup, or reception of keystrokes from a keyboard are stored in a non-volatile memory device. According to example implementations, the computing device architecture 100 includes a storage medium 122 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), for storing files include an operating system 124, application programs 126 (including, for example, a web browser application, a widget or gadget engine, and or other applications, as necessary), and data files 128. According to example implementations, the computing device architecture 100 includes a power source 130 that provides an appropriate alternating current (AC) or direct current (DC) to power components.

According to an example implementation, the computing device architecture 100 includes a telephony subsystem 132 that allows the device 100 to transmit and receive audio and data information over a telephone network. Although shown as a separate subsystem, the telephony subsystem 132 may be implemented as part of the network connection interface 112. The constituent components and the CPU 102 communicate with each other over a bus 134.

According to an example implementation, the CPU 102 has appropriate structure to be a computer processor. In one arrangement, the CPU 102 includes more than one processing unit. The RAM 118 interfaces with the computer bus 134 to provide quick RAM storage to the CPU 102 during the execution of software programs such as the operating system, application programs, and device drivers. More specifically, the CPU 102 loads computer-executable process steps from the storage medium 122 or other media into a field of the RAM 118 to execute software programs. Data may be stored in the RAM 118, where the computer CPU 102 can access data during execution. In one example configuration, the device architecture 100 includes at least 128 MB of RAM, and 256 MB of flash memory.

The storage medium 122 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 122, which may include a machine-readable storage medium.

According to example implementations, the term “computing device,” as used herein, may be a CPU, or conceptualized as a CPU (for example, the CPU 102 of FIG. 1). In such example implementations, the computing device (CPU) may be coupled, connected, and/or in communication with one or more peripheral devices, such as display. In other example implementations, the term “computing device,” as used herein, may refer to a mobile computing device such as a smartphone, tablet computer, or smart watch. In such implementations, the computing device may output content to its local display and/or speaker(s). In another example implementation, the computing device may output content to an external display device (e.g., over Wi-Fi) such as a TV or an external computing system.

In example implementations of the disclosed technology, a computing device includes any number of hardware and/or software applications that are executed to facilitate any of the operations. In example implementations, one or more I/O interfaces facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks (e.g., a local area network, a wide area network, the Internet, a cellular network, a radio frequency network, a Bluetooth enabled network, a Wi-Fi enabled network, a satellite-based network any wired network, any wireless network, or other suitable network) for communication with external devices and/or systems.

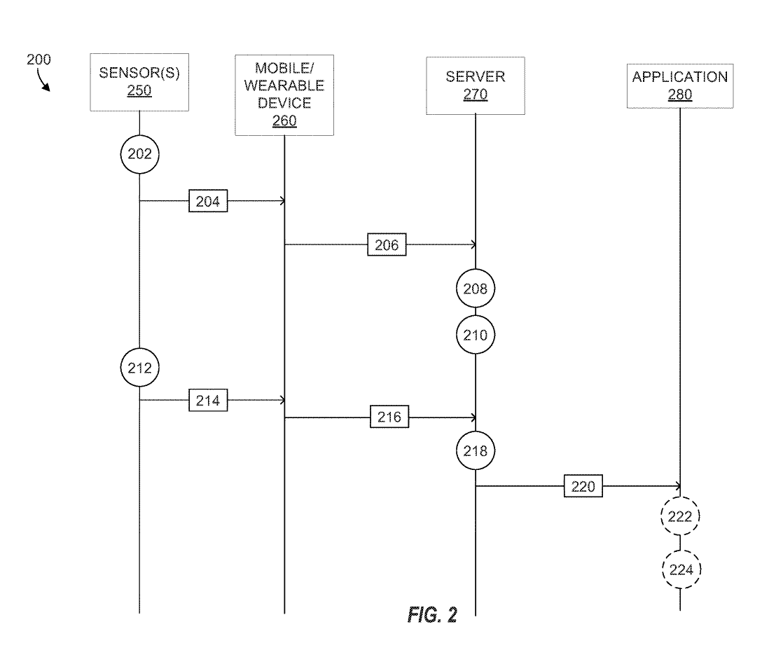

FIG. 2 illustrates an example communication flow 200, according to some implementations of the disclosed technology. In example implementations, sensors associated with a mobile device or wearable device (which can be the same device and be referred to alternatively as a computing device, and which can comprise some or all of computer architecture 100) can detect changes in a user's physical status or location. At a high level, a change in physical status can represent an indication that the user has become distracted from the content the user is experiencing (i.e., that the user has transitioned from an original (or first) physical status to an alternate (or second) physical status). Thus, for example, if a user is watching a television program or movie or is listening to music, and the user begins a conversation, the act of beginning the conversation would represent a change in physical status in that the user would be distracted from the content the user was experiencing (i.e., the television program, movie, or music). In addition to beginning a conversation, other changes in physical status could include falling asleep or shifting body position away from the source of the media content (e.g., television, stereo, or other source). In some implementations, a user's interaction with their mobile or wearable device could be a change in physical status. For example, answering a phone call, checking and/or responding to a text message or email, interacting with an application on the device (e.g., an Internet browser, game, or other application), or activating a different source or media content can constitute a change in physical activity. Further, an external source that distracts the user from the media content can constitute a change in physical activity. For example, a passing ambulance or fire engine, an announcement over a loudspeaker, or a barking dog can constitute a change in physical activity. A change in location similarly can indicate that the user is distracted from the media content in that the user has moved a threshold distance away from the source of the audio content. For example, the user may go into a different room (e.g., to answer the door, get something from the kitchen, use the restroom), or move away from the source of the media content, in which case the user may no longer be able to see or hear the television program, movie, music, or other visual content (i.e., the user transitions from an original (or first) location to an alternate (or second) location).

In an example implementation, and as shown in FIG. 2, one or more sensors 250 associated with a wearable or mobile device 260 can detect 202 a change in the user's physical status or location. Thus, for example, a microphone can detect 202 that a user has started a conversation (i.e., that the user's physical status has changed). Similarly, in an example implementation, the microphone can detect 202 the siren of a passing fire engine or ambulance, or it can detect a barking dog. A gyroscope or other sensor 250 can detect 202 that the user has turned or shifted their body position away from the source of the media content or that the user has fallen asleep. As shown in FIG. 2, upon detecting 202 the change in physical status, the sensor 250 can provide 204 a notification of the change in physical status to the mobile or wearable device 260. Put differently, the one or more sensors 250 may detect 202 sound or movement and provide 204 an indication of the detected sound or movement to the mobile or wearable device 260, which may then determine there has been a change in physical status. For example, the mobile or wearable device 260 may determine there is a change in physical status if a sensor 250 detects sound above a particular noise threshold or sound that occurs longer than a threshold period of time (e.g., five seconds, ten seconds, etc.). Similarly, a sensor 250 (e.g., pedometer, gyroscope, accelerometer, or other sensor) may detect 202 user movement that indicates that the user's location has changed and provide 204 an indication of that change to the mobile or wearable device 260. In some implementations, the sensor 250 may provide 204 an indication of the movement to the mobile or wearable device 260, which can determine there has been a change in physical location (e.g., that the user has moved a threshold distance from the source of the media content). Similarly, a combination of sensors 250 (e.g., a pedometer and a microphone) may detect movement by a user and a change in the volume of the media content that may indicate a change in location, which the sensors 250 can provide 204 to the mobile or wearable device 260.

As shown in FIG. 2, responsive to receiving an indication of a change in physical activity or location, a mobile or wearable device 260 can provide 206 to the server 270 an indication of the change in physical status or change in location. As will be understood, server 270 may include some or all of computer architecture 100 and can alternately be referred to as server 270. Upon receiving the indication of status or location change, the server 270 can generate 208 and store 210 in memory (e.g., RAM 118 or ROM 120) a timestamp associated with the status or location change (i.e., a timestamp that indicates when the status or location change occurred).

As further shown in FIG. 2, after some period of time, the one or more sensors 250 can detect 212 that the physical status has reverted back to the original physical status. Thus, for example, the sensor 250 can detect 212 that the conversation that previously was detected 202 has concluded. Similarly, the sensor 250 can detect 212 that the siren detected 202 previously has passed (i.e., that the siren is no longer in audible range). In an alternate example, the sensor 250 can detect 212 that the user who was detected 202 to be sleeping is now awake. Accordingly, in the foregoing examples, the sensor 250 determines 212 that the user's physical status has reverted from the alternate physical status to the original physical status. Similarly, the sensor 250 can determine that the user's location has returned to the original location from the alternate location (i.e., the user has returned to a location that is within a threshold visual or audible range of the source of the media content). Similarly to as described above, in some implementations, after detecting 212 that the user's physical status or location has reverted back to its original state, the sensor 250 can provide 214 an indication of the reversion to the original status or location to the mobile or wearable device 260. Put differently, the one or more sensors 250 may detect 212 sound or movement and provide 214 an indication of the detected sound or movement to the mobile or wearable device 260, which may then determine there has been a reversion to the original physical status or location.

As shown in FIG. 2, in some implementations, upon receiving an indication that the physical status or location has reverted back to its original state (or upon making such a determination), the mobile or wearable device 260 can provide 216 to the server 270 an indication of the status or location change. Upon receiving the indication, the server 270 can access 218 the timestamp from memory (e.g., RAM 118) and provide 220 data representative of the timestamp to the application 280 that is making the content available to the user. As will be understood, the application 280 can be a smart TV (alternatively, hybrid or connected TV), set-top box, digital media player, portable media player, digital audio player, microconsole, or other connected device for making content (music, movies, television, videos, or other content) available to users. Upon receiving the indication, the application 280 can automatically revert 222 the content (i.e., rewind the content) to the point at which the user's physical status or location changed (i.e., the time indicated by the timestamp). As will be appreciated, by reverting 222 (i.e., rewinding) the content to this point, the application 280 returns the content to the point in time at which the user became distracted from the content. In some implementations, instead of automatically reverting the content, the application 280 may output 224 a prompt for display to the user that gives the user the option to revert the content back to the point in time where the status or location change occurred. As will be understood, in some implementations, the user has a device (e.g., remote control) or application (e.g., an application on the user's mobile or wearable device 260) capable of communicating with the application 280. Accordingly, the user can provide an input to the device capable of communicating with the application 280 that indicates whether the user would like the application 280 to revert the content. In some implementations, the data indicative of the timestamp can initiate playback of the media content at a position associated with the timestamp or instruct the application 280 to output a prompt for display that gives the user the option to revert the content to the time associated with the timestamp.

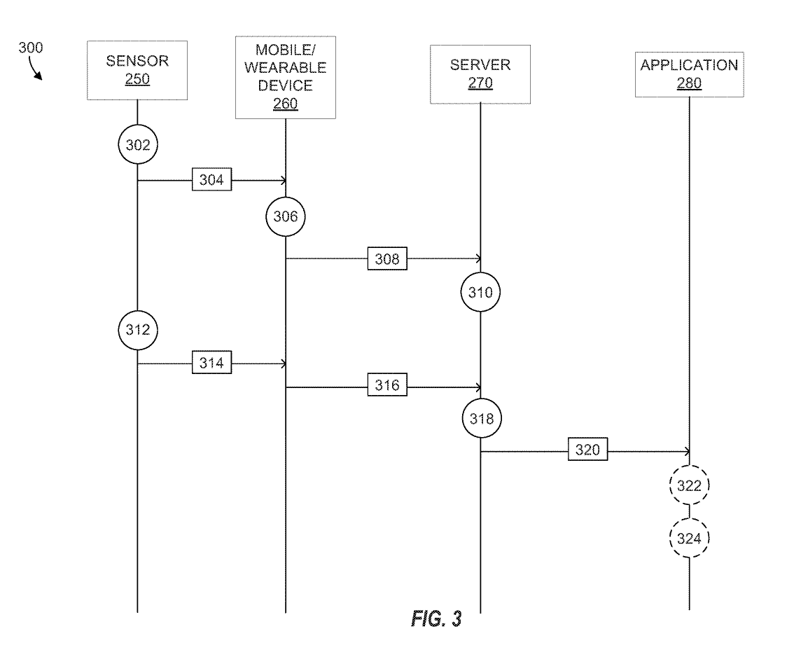

FIG. 3 illustrates an example communication flow 300, according to some implementations of the disclosed technology, which in many respects is similar to the communication flow 200 illustrated in FIG. 2. As shown in FIG. 3, in some implementations, one or more sensors 250 may detect 302 a change in a user's physical status or location and communicate 304 that change to an associated mobile or wearable device 260. Put differently, the sensor 250 (or combination of sensors 250) can detect 302 sound or movement and provide 304 an indication of that sound or movement to the mobile or wearable device 260, which can then determine there has been a change in physical status or location. As shown in FIG. 3, in some implementations, upon receipt of the notification, the mobile or wearable device 260 can create 306 a timestamp associated with the change in physical status or location and transmit 308 data representative of the timestamp to a server 270, which may be a remote server. The server 270 can then store 310 the timestamp (or data representative of the timestamp) in memory (e.g., RAM 118).

As shown in FIG. 3, in some implementations, the sensors 250 can then detect 312 a reversion to the user's original physical status or location. In response, the sensor 250 can provide 314 an indication of the reversion to the original status or location to the mobile or wearable device 260. Put differently, the one or more sensors 250 may detect 312 sound or movement and provide 314 an indication of the detected sound or movement to the mobile or wearable device 260, which may then determine there has been a reversion to the original physical status or location. The mobile or wearable device 260 can then provide 316 to the server 270 an indication of the reversion of the physical status or location. Upon receipt of the indication, the server 270 can retrieve (or access) 318 the timestamp from memory and provide 320 data indicative of the timestamp to the application 280. Upon receipt of the indication, the application can automatically revert 322 the content to the time indicated by the timestamp or, alternatively, output 324 a prompt for the user to provide an indication of whether they would like to revert the content to the point indicated by the timestamp.

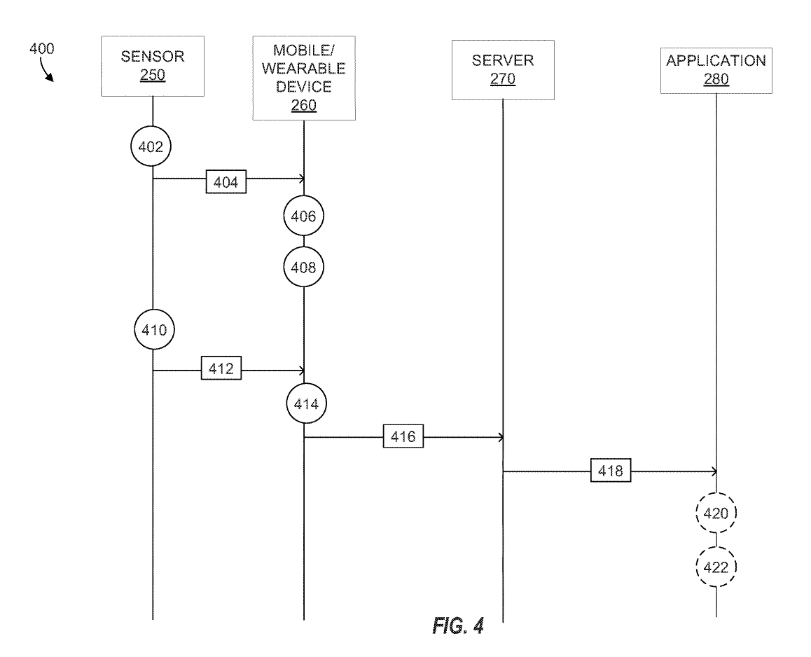

FIG. 4 illustrates an example communication flow 400, according to some implementations of the disclosed technology, which in many respects is similar to the communication flow 200 illustrated in FIG. 2. As shown in FIG. 4, in some implementations, one or more sensors 250 may detect 402 a change in a user's physical status or location and communicate 404 that change to an associated mobile or wearable device 260. Put differently, the sensors 250 may detect 402 movement or sound and provide 404 an indication of that movement or sound to the mobile or wearable device 260, which can then determine there has been a change in physical status or location. As shown in FIG. 4, in some implementations, upon receipt of the notification, the mobile or wearable device 260 can create 406 a timestamp associated with the change in physical status or location and then store 408 the timestamp (or data representative of the timestamp) in memory (e.g., RAM 118 or ROM 120). Later, and as shown in FIG. 4, the sensors 250 can detect 410 that the user's physical status or location has reverted to its original state. In response, the sensor 250 can provide 412 to the mobile or wearable device 260 an indication of the reversion to the original status or location. Put differently, the one or more sensors 250 may detect 410 sound or movement and provide 412 an indication of the detected sound or movement to the mobile or wearable device 260, which may then determine there has been a reversion to the original physical status or location. The mobile or wearable device 260 can then retrieve 414 the timestamp (or data indicative thereof) and provide 416 data indicative of the timestamp to the server 270, which can provide 418 data indicative of the timestamp to the application 280. Once the application 280 receives the data indicative of the timestamp, the application 280 can automatically revert 420 the content to the time indicated by the timestamp or, alternatively, output 422 a prompt for the user to provide an indication of whether they would like to revert the content to the point indicated by the timestamp.

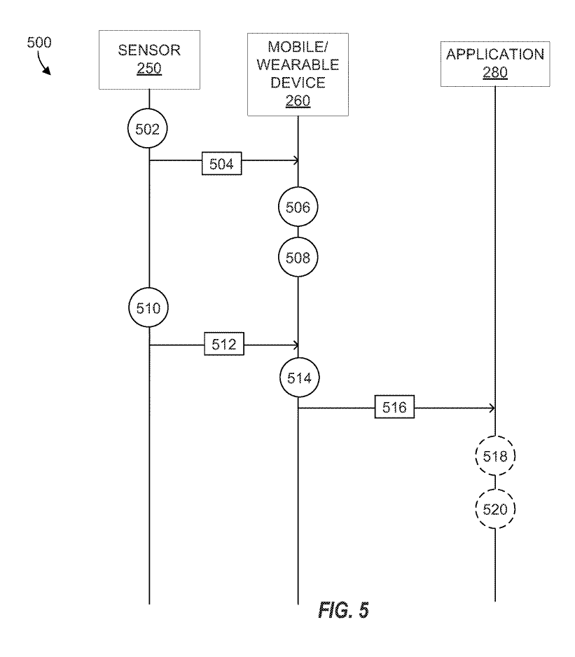

FIG. 5 illustrates yet another example communication flow 500, according to some implementations of the disclosed technology, which in many respects also is similar to the communication flow 200 illustrated in FIG. 2. As shown in FIG. 5, and as discussed previously, in some implementations, one or more sensors 250 may detect 502 a change in a user's physical status or location and communicate 504 that change to an associated mobile or wearable device 260. Put differently, the sensors 250 may detect 502 movement or sound and provide 504 an indication of that movement or sound to the mobile or wearable device 260, which can then determine there has been a change in physical status or location. Upon receipt of the notification, as shown in the implementation illustrated in FIG. 5, the mobile or wearable device 260 can create 506 a timestamp associated with the change in physical status or location and then store 508 the timestamp (or data representative of the timestamp) in memory (e.g., RAM 118 or ROM 120). Subsequently, and as shown in FIG. 5, the sensors 250 can detect 510 that the user's physical status or location has reverted to its original state. In response, the sensor 250 can provide 512 to the mobile or wearable device 260 an indication of the reversion to the original status or location. The mobile or wearable device 260 can then retrieve 514 the timestamp (or data indicative thereof) and provide 516 the data indicative of the timestamp to the application 280. Once the application 280 receives the data indicative of the timestamp, the application 280 can automatically revert 518 the content to the time indicated by the timestamp or, alternatively, output 520 a prompt for the user to provide an indication of whether they would like to revert the content to the point indicated by the timestamp.

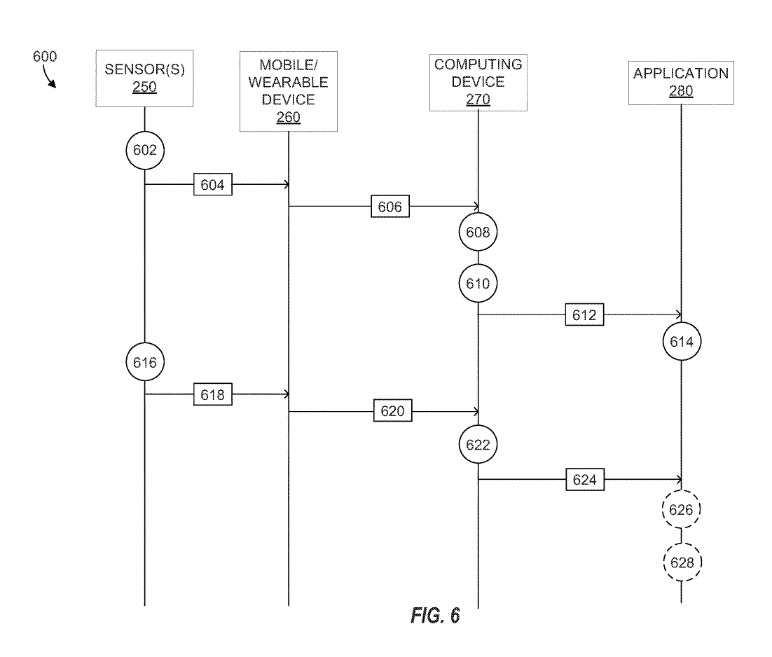

FIG. 6 illustrates an example communication flow 600, according to some implementations of the disclosed technology, which in many respects is similar to the communication flow 200 illustrated in FIG. 2. As shown in FIG. 6, in some implementations, one or more sensors 250 may detect 602 a change in a user's physical status or location and communicate 604 that change to an associated mobile or wearable device 260. Put differently, the sensor 250 (or combination of sensors 250) can detect 602 sound or movement and provide 604 an indication of that sound or movement to the mobile or wearable device 260, which can then determine there has been a change in physical status or location. As shown in FIG. 6, in some implementations, upon receipt of the notification, the mobile or wearable device 260 can provide 606 to the server 270 an indication of the change in physical status or change in location. Upon receiving the indication of status or location change, the server 270 can generate 608 and store 610 in memory (e.g., RAM 118) a timestamp associated with the status or location change (i.e., a timestamp that indicates when the status or location change occurred). Further, as shown in FIG. 6, in some implementations, the server 270 can provide 612 to an application 280 an instruction to the application 280 to create (or generate) 614 a version of the media content that begins at the timestamp that can be stored in memory or a storage device that is accessible by the application 280. As will be appreciated, by creating 614 and storing an alternate version of the content that begins at the timestamp, the application 280 can later access the alternate version of the media content and begin immediate playback at the timestamp. It will be understood by one of skill in the art that, while FIG. 6 shows the server 270 providing 612 the timestamp and instruction to create 614 the alternate version of the content, the mobile or wearable device 260 could likewise provide the instruction directly to the application 280.

As shown in FIG. 6, in some implementations, the sensors 250 can later detect 616 a reversion to the user's original physical status or location. In response, the sensor 250 can provide 618 an indication of the reversion to the original status or location to the mobile or wearable device 260. Put differently, the one or more sensors 250 may detect 616 sound or movement and provide 618 an indication of the detected sound or movement to the mobile or wearable device 260, which may then determine there has been a reversion to the original physical status or location. The mobile or wearable device 260 can then provide 620 to the server 270 an indication of the reversion of the physical status or location. Upon receipt of the indication, the server 270 can retrieve (or access) 622 the timestamp from memory and provide 624 data indicative of the timestamp (or another instruction) to the application 280. Upon receipt of the data indicative of the timestamp or other instruction, the application can automatically revert 626 the content to the time indicated by the timestamp. In some implementations, the data indicative of the timestamp can include an instruction to retrieve the alternate version of the content that begins at the timestamp. Alternatively, the application 280 can output 628 a prompt for the user to provide an indication of whether they would like to revert the content to the point indicated by the timestamp.

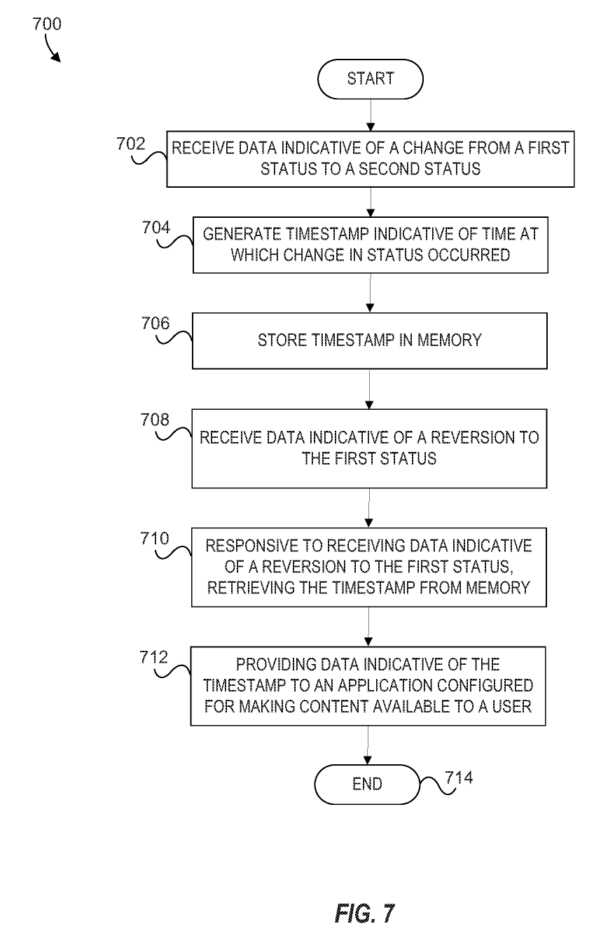

FIG. 7 is a flow diagram of a method 700 according to an example implementation of the disclosed technology. As shown, the method 700 begins with a computing device receives 702 an indication of a change from an original (or first) status to an alternate (or second) status from, for example, a mobile or wearable computing device. Responsive to receiving the indication of status change, the computing device can generate 704 a timestamp indicating when the status change occurred. Further, the computing device can store 706 in memory (e.g., RAM 118) the timestamp (or data indicative thereof). Subsequently, the computing device receives 708 an indication of a reversion to the original (or first) status. Responsive to receiving the indication, the method 700 includes retrieving 710 the timestamp (or data indicative thereof) from the memory. The method 700 further includes providing 712 data indicative of the timestamp to an application configured for providing content to a user. As discussed herein, the data indicative of the timestamp can initiate an automatic playback of content being presented to the user to a point in time corresponding to the timestamp. Alternatively, the data indicative of the timestamp can initiate outputting of a prompt to the user requesting the user to indicate whether he would like the content to revert to the point in time associated with the timestamp. After providing 712 data indicative of the timestamp, the method 700 ends 714.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. The computer program instructions also may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, Internet tablets, PDAs, ultra mobile PCs (UMPCs) and smartphones.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer-implemented method comprising:
receiving, by a computing device, an indication of a change from a first physical status of a user to a second physical status of the user, wherein the change from the first physical status to the second physical status occurs at a first time, and wherein the user is a user of media content;
generating a timestamp indicative of the first time;
storing, in memory operatively coupled to the computing device, data indicative of the timestamp;
responsive to receiving, by the computing device, an indication of a reversion by the user to the first physical status, accessing, from the memory, the data indicative of the timestamp; and
providing, to a media content application, data indicative of the timestamp.

2. The method of claim 1, wherein the data indicative of the timestamp is configured to initiate playback of the media content at a position in the media content associated with the timestamp.

3. The method of claim 1, wherein the data indicative of the timestamp is configured to initiate output of a prompt for display, the prompt providing the user an option to indicate to the media content application a desire to revert the media content to a position in the media content associated with the timestamp.

4. The method of claim 1, wherein the first physical status is awake and the second physical status is asleep.

5. The method of claim 1, wherein the first physical status is not talking and the second physical status is talking.

6. The method of claim 1 further comprising:
responsive to generating the timestamp, providing, to the media content application, an instruction to generate an alternate version of the media content that begins at the first time.

7. The method of claim 6, wherein data indicative of the timestamp includes an instruction to retrieve the alternate version of the media content and output, for display, the alternate version of the media content.

8. A computer-implemented method comprising:
receiving, by a computing device, an indication of a change from a first location of a user to a second location of the user, wherein the change from the first location to the second location occurs at a first time, and wherein the user is a user of media content;
generating a timestamp indicative of the first time;
storing, in memory operatively coupled to the computing device, data indicative of the timestamp;
responsive to receiving, by the computing device, an indication of a reversion by the user to the first location, accessing, from the memory, the data indicative of the timestamp; and
providing, to a media content application, data indicative of the timestamp.

9. The method of claim 8, wherein the data indicative of the timestamp is configured to initiate playback of the media content at a position in the media content associated with the timestamp.

10. The method of claim 8, wherein the data indicative of the timestamp is configured to initiate output of a prompt for display, the prompt providing the user an option to indicate to the media content application a desire to revert the media content to a position in the media content associated with the timestamp.

11. The method of claim 8 further comprising:
responsive to generating the timestamp, providing, to the media content application, an instruction to generate an alternate version of the media content that begins at the first time.

12. The method of claim 11, wherein data indicative of the timestamp includes an instruction to retrieve the alternate version of the media content and output, for display, the alternate version of the media content.

13. A system comprising:
one or more processors;
a memory coupled to the one or more processors and storing instructions that, when executed by the one or more processors, cause the system to:
receive an indication of a change from a first physical status of a user to a second physical status of the user, wherein the change from the first physical status to the second physical status occurs at a first time, and wherein the user is a user of media content;
generate a timestamp indicative of the first time;
store data indicative of the timestamp;
responsive to receiving an indication of a reversion by the user to the first physical status, access the data indicative of the timestamp; and
provide, to a media content application, data indicative of the timestamp.

14. The system of claim 13, wherein the data indicative of the timestamp is configured to initiate playback of the media content at a position in the media content associated with the timestamp.

15. The system of claim 13, wherein the data indicative of the timestamp is configured to initiate output of a prompt for display, the prompt providing the user an option to indicate to the media content application a desire to revert the media content to a position in the media content associated with the timestamp.

16. The system of claim 13, wherein the first physical status is awake and the second physical status is asleep.

17. The system of claim 13, wherein the first physical status is not talking and the second physical status is talking.

18. The system of claim 13, the memory further storing instructions that, when executed by the one or more processors, cause the system to:
responsive to generating the timestamp, provide, to the media content application, an instruction to generate an alternate version of the media content that begins at the first time.

19. The system of claim 18, wherein data indicative of the timestamp includes an instruction to retrieve the alternate version of the media content and output, for display, the alternate version of the media content.
